(19) United States
(12) Patent Application Publication
(10) Pub. No.: US 2014/0114846 A1
(43) Pub. Date: Apr. 24, 2014

(54) TRANSACTION SYSTEM AND METHOD FOR USE WITH A MOBILE DEVICE

(71) Applicant: Avish Jacob Weiner, Tel Aviv (IL)

(72) Inventor: Avish Jacob Weiner, Tel Aviv (IL)

(73) Assignee: ACCELLS TECHNOLOGIES, LTD., Tel Aviv (IL)

(21) Appl. No.: 14/124,719

(22) PCT Filed: Jun. 7, 2012
(86) PCT No.: PCT/IL2012/050199

§ 371 Date: Dec. 8, 2013

Related U.S. Application Data
(60) Provisional application No. 61/494,946, filed on Jun. 9, 2011.
(60) Provisional application No. 61/504,754, filed on Jul. 6, 2011.
(60) Provisional application No. 61/529,258, filed on Aug. 31, 2011.
(60) Provisional application No. 61/566,660, filed on Dec. 4, 2011.

(51) Int. Cl. G06Q 20/32

(52) U.S. Cl. CPC G06Q 20/322
USPC 705/39

(57) ABSTRACT

A transaction system constituted of: a mobile device comprising a display; a transaction server; and a communication network arranged to provide communication between the mobile device and the transaction server, wherein the mobile device is arranged to transmit identification information to the transaction server via the communication network, and wherein the transaction server is arranged to: identify the mobile device responsive to the mobile device transmitted identification information; associate the identified mobile device with a particular access point; transmit, via the communication network, trans action information to the mobile device, the transmitted transaction information responsive to the associated particular access point, wherein the mobile device is arranged to output onto the display information responsive to the transmitted transaction information.

### CROSS-REFERENCE TO RELATED APPLICATIONS

This application claims priority from U.S. Provisional Patent Application Ser. No. 61/494,946 filed Jun. 6, 2011 entitled “SYSTEM AND METHOD FOR PERFORMING A SECURE TRANSACTION”; U.S. Provisional Patent Application Ser. No. 61/504,754 filed Jul. 6, 2011 entitled “SYSTEM AND METHOD FOR PERFORMING A SECURE TRANSACTION”; U.S. Provisional Patent Application Ser. No. 61/529,258 filed Aug. 31, 2011 entitled “METHOD AND APPARATUS FOR SECURE TRANSACTIONS WITH A MOBILE DEVICE”; and U.S. Provisional Patent Application Ser. No. 61/566,660 filed Dec. 4, 2011 entitled “SYSTEM AND METHOD FOR SECURE TRANSACTION PROCESS VIA MOBILE DEVICE”, the entire contents of each of which are incorporated herein by reference.

### TECHNICAL FIELD

The present disclosure relates generally to the field of transaction systems and in particular to a system and method for providing transaction relevant information in cooperation with a mobile device and a transaction server.

### BACKGROUND ART

Payments by credit or debit cards represent a large portion of consumer spending. Historically, credit or debit cards were encoded with a magnetic stripe, which allows a transaction responsive to a transaction device which is arranged to read information encoded on the magnetic stripe, in a secured manner. The device reading the magnetic stripe is typically in communication with the credit card issuer via a transaction network, the credit card issuer ultimately approving the transaction. Credit or debit cards are unfortunately susceptible to theft which may be unrealized by the user for a significant period of time.

Advances in technology have led to the development of contactless smart cards, such as those defined under ISO/IEC 7810 and ISO/IEC 14443, also known as Near Field Communication (NFC). Similar technology is available meeting other standards or protocols generally under the term radio frequency identification (RFID), with the range of RFID typically restricted to be of the same order as that of NFC. The term contactless element (CE) as used throughout this document refers to any short range communication device operating under any of NFC, RFID or other short range communication standard with range on the same order as that of NFC, and typically require that the CE be juxtaposed with a reader. The use of optically readable codes are specifically included herein with the definition of a CE. Such CE smart cards may be used for transactions, however since they may be read by any reader within about 4 cm, they do not provide for increased security. As such, CE smart cards are typically only used for low value transactions, wherein a small value is pre-loaded on the CE smart card, and the small value is depreciated with each transaction until a limit is reached.

Mobile devices (MDs) are increasingly being used for financial transactions due to their ubiquity, available screen and input devices. An MD as used herein includes any electronic MD used for personal functionalities such as multimedia playing, data communication over a network or voice communication. One embodiment of an MD is a mobile station, also known as a mobile communication device, mobile phone, mobile telephone, hand phone, wireless phone, cell phone, cellular phone, cellular telephone, mobile handset or cell telephone.

With the development of IEEE 802.11, and the broad establishment of the resultant wireless networks, various MDs have been developed which communicate over available wireless networks in addition to cellular telephone capabilities. Furthermore, various MDs have been developed with the ability to access the Internet both over a wireless network and/or over a cellular network.

The ubiquitous MD, having an associated means for user identification and charging expenses, presents an opportunity to utilize the MD as an electronic wallet. There are several known methods for providing a service or a product, and in particular payment for products or services other than phone usage or airtime, by using a mobile station.

CEs in cooperation with an MD have been developed into two main groups, devices which are connected to a controller of the MD, such as to the MD's CPU, and can communicate therewith, and devices which are not connected to the MD's CPU. In the case of CEs connected to the MD's CPU one can find various devices, such as NFC devices on SIM cards, also known as “SIM Contactless Element” (SCE), external cards such as SD cards with NFC devices, SIM add-on Contactless Elements (SCCE), and NFC devices found within the MD's hardware. The above group of devices known as “embedded CE” (ECE) devices can be used in the same manner as CE devices which are not connected to the MD's CPU for applications where the CE reader communicates with the CE device directly and the communication doesn't rely on any action of the MD's CPU. It is to be noted that in the event that the CE comprises an optically readable code displayed on a display of the MD, the MD is inherently an ECE device.

The group of CEs which are not connected to an MD CPU may include NFC or RFID tags, stickers, key fobs, optically readable codes which may be affixed to the MD, without limitation. Such a CE, when secured in relation to the MD, may thus be utilized to provide an identification number read by a reader within proximity of the CE. In one embodiment, the CE includes identification information which may be secured or installed and protected, the information generated by a secured element (SE).

An SE is defined herein as a tamper proof element arranged to embed applications with the required level of security and features. In further detail, an SE is an element wherein access to data or functions stored in the SE is controlled by security levels such that only authorized parties may access the data or functions. Thus, contents of the SE can not be copied, written to, or read from, without a predetermined security key, access to which is controlled. The term security key is particularly addressed in this application to keys as known in cryptography, and is not meant to be a physical, or mechanical key. Typically security is provided in cooperation with one or more keys which are controlled by the SE issuer. The SE may be supplied as part of the CE, as part of the MD, or as an additional element which is removable form the MD. There is no limitation to the number of SEs on an MD, and in particular a plurality of SEs may coexist on a single MD. One of the SE's may be implemented on a single subscriber identity module (SIM) without limitation.

As transaction systems have become more sophisticated and in more widespread use, the incidence of fraudulent transactions have also increased. In particular, both “phishing” and “man in the middle” attacks have been shown to defeat many CE based security systems. In a phishing attack, a user is sent a message indicating that connection to a specific uniform resource locator (URL) is required, however the URL, while appearing to be a legitimate URL, is actually that of a fraudulent server. The user may not recognize, or notice, the slight change in URL, whose actual address refers to a fraudulent server. In such a manner personal information and passwords may be obtained from an unsuspecting user.

Man in the middle attacks are particularly useful against ECE devices, wherein the CE may be read by a fraudulent reader, and relayed to a remote purchasing location without the user being aware.

A CE enabled MD may be further compromised by the ability of a CE reader enabled malfeasant. A malfeasant, coming into close proximity of the CE enabled MD, may read any publicly available information from the CE and further write inappropriate instructions into any available unprotected memory locations of the CE.

CE enabled posters have recently become common, with the poster having embedded CE devices therein. A user with an ECE juxtaposes the CE with an embedded CE, which acts to generate a pointer on the MD to a target URL, perhaps offering a discount. Unfortunately, a legitimate embedded CE may be covered by a fraudulent embedded CE, or may be covered by a blocking material with an adjacent fraudulent CE attached, causing the MD to generate a pointer to a fraudulent URL.

An additional difficulty arises as MDs become more sophisticated. In particular, malicious software such as key logger software may be surreptitiously added to an MD, thus allowing a malfeasant to obtain any personal information number (PIN) information. Other malicious software may in fact take over the MD, and allow a malfeasant to control the MD and run any payment software.

Furthermore, as the use of MD based transactions increases, it would be preferably to improve the security and flexibility of MD based transactions, which is not fully supported by the prior art.

### SUMMARY OF INVENTION

In view of the discussion provided above and other considerations, the present disclosure provides methods and apparatus to overcome some or all of the disadvantages of prior and present methods of performing a secure transaction. Other new and useful advantages of the present methods and apparatus will also be described herein and can be appreciated by those skilled in the art.

Certain embodiments enable a transaction system comprising: a mobile device comprising a display; a transaction server; and a communication network arranged to provide communication between the mobile device and the transaction server, wherein the mobile device is arranged to transmit identification information to the transaction server via the communication network, and wherein the transaction server is arranged to: identify the mobile device responsive to the mobile device transmitted identification information; associate the identified mobile device with a particular access point; transmit, via the communication network, transaction information to the mobile device, the transmitted transaction information responsive to the associated particular access point, wherein the mobile device is arranged to output onto the display information responsive to the transmitted transaction information.

In one embodiment, the transaction server is arranged to obtain location information regarding the mobile device, the association of the identified mobile device with the particular access point responsive to the obtained location information. In another embodiment, the transaction server is in communication with an electronic wallet functionality associated with the mobile device, and wherein the transaction information is further responsive to the electronic wallet functionality. In one further embodiment, the mobile device is further provided with an input device, and wherein the mobile device is arranged to: allow for modification of the transaction information responsive to the input device; and transmit information regarding the modification to the server.

In one embodiment, the particular access point is a web server. In one further embodiment, the transaction system further comprises: a user device arranged to provide at least some identification information associated with the mobile device to the web server, wherein the web server is arranged to transmit the user device provided identification information to the transaction server, the transaction server arranged to obtain an address of the mobile device responsive to the transmitted user device provided identification information.

In another embodiment, the mobile device transmitted identification information comprises a pseudo random number generated responsive to a key. In one further embodiment, the mobile device is further provided with an input device, and wherein the mobile device transmitted identification information comprises a pseudo random number generated responsive to a personal identification number entered via the input device.

In one yet further embodiment, the mobile device comprises a secure element arranged to: generate the pseudo random number generated responsive to the key; and generate the pseudo random number generated responsive to the personal identification number. In one yet even further embodiment, the secure element further comprises a quarantine functionality arranged to: read data via a communication interface; quarantine the read data; and transmit the quarantined data to the transaction server.

In one further embodiment, the mobile device transmitted identification information further comprises an unencrypted readable identifier. In another further embodiment, the transaction system further comprises a secure device in communication with the mobile device, wherein the pseudo random number generated responsive to the key is generated by the secure device and transmitted to the mobile device via a short range communication.

In one embodiment, the transaction system further comprises at least one of a loyalty platform and a coupons platform in communication with the transaction server, wherein the transmitted transaction information is further responsive to the at least one platform.

In one independent embodiment, a method of providing transaction information is provided, the method comprising: transmitting identification information from a mobile device to a transaction server; identifying the mobile device responsive to the mobile device transmitted identification information; associating the identified mobile device with a particular access point; transmitting transaction information to the mobile device, the transmitted transaction information responsive to the associated particular access point; and outputting onto a display of the mobile device information responsive to the transmitted transaction information.

In one embodiment, the method further comprises: obtaining location information regarding the mobile device, wherein the associating the identified mobile device with the particular access point is responsive to the obtained location information. In another embodiment, the transmitted transaction information is further responsive to an electronic wallet functionality. In one further embodiment, the method further comprises: enabling modification of the transaction information responsive to an input device of the mobile device; and transmitting information regarding the modification to the transaction server.

In one embodiment, the particular access point is a web server. In one further embodiment, the method further comprises: providing a user device arranged to provide at least some identification information associated with the mobile device to the web server; transmitting the user device provided identification information from the web server to the transaction server; and obtaining an address of the mobile device responsive to the transmitted user device provided identification information.

In another embodiment, the method further comprises: generating a first pseudo random number generated responsive to a key, wherein the provided mobile device transmitted identification information comprises the generated first pseudo random number. In one further embodiment, the method further comprises: providing the mobile device, wherein the provided mobile device is further provided with an input device; and generating a second pseudo random number responsive to a personal identification number entered via the input device, wherein the mobile device transmitted identification information further comprises the generated second pseudo random number.

In one yet further embodiment, the provided mobile device comprises a secure element arranged to generate the first and second pseudo random numbers. In one yet even further embodiment, the secure element performs a method comprising: reading data via a communication interface; quarantining the read data; and transmitting the quarantined data to the transaction server.

In one further embodiment, the mobile device transmitted identification information further comprises an unencrypted readable identifier. In another further embodiment, the method further comprises providing a secure device, wherein the first pseudo random number generated responsive to the key is generated by the secure device, the method further comprising transmitting the first pseudo random number to the mobile device via a short range communication.

In one embodiment, the transmitted transaction information is further responsive to one of a loyalty platform and a coupons platform.

Additional features and advantages of the invention will become apparent from the following drawings and description.

### BRIEF DESCRIPTION OF DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A illustrates a high level block diagram of the advantageous partitioning of certain embodiments;

FIG. 1B illustrates a high level architecture of an MD, in cooperation with a CE and in communication with a check point;

FIG. 2 illustrates a transaction flow utilizing the various domains of FIG. 1A in cooperation with the architecture of FIG. 1B;

FIG. 3 illustrates a transaction flow utilizing the various domains of FIG. 1A in the absence of an access point poster;

FIG. 4 illustrates a high level block diagram of an embodiment of the arrangement of FIG. 1A, wherein the check point is replaced by a web server;

FIG. 5 illustrates a transaction flow utilizing the various domains of FIG. 4;

FIG. 6A illustrates a transaction flow utilizing the various domains of FIG. 1A;

FIG. 6B illustrates the transaction flow of FIG. 6A, where the customer MD peripheral identification information transmitted to the TS does not match information stored on the TS, or when the communication link does not allow for automatic detection of a customer MD;

FIG. 6C further details certain portions of the transaction flow of FIG. 6A wherein an authorization number with auto-approval limit has been received by the TS;

FIG. 6D illustrates the transaction flow of FIG. 6C, when the transaction amount is greater than an amount authorized by the issuer;

FIG. 6E illustrates the transaction flow of FIG. 6D, where TS requests approval from a customer MD after receiving an authorization request message from a check point;

FIG. 7 illustrates a high level block diagram of advantageous partitioning of certain embodiments allowing for web out of band login (OOBL);

FIG. 8 illustrates a transaction flow utilizing the various domains of FIG. 7;

FIG. 9 illustrates a high level block diagram of advantageous partitioning of certain embodiments, where the financial settlement functionality is based on an existing financial back bone; and

FIG. 10 illustrates a transaction flow utilizing the various domains of FIG. 9.

### DESCRIPTION OF EMBODIMENTS

Before explaining at least one embodiment in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. In particular, the term connected as used herein is not meant to be limited to a direct connection and includes communication of any sort, and allows for intermediary devices or components without limitation.

In the following description, the term mobile device (MD) includes any electronic mobile device used for personal functionalities such as multimedia playing, data communication over a network or voice communication, including but not limited to a mobile station (MS). For clarity, the term MS refers to any mobile communication device, mobile phone, mobile telephone, hand phone, wireless phone, cell phone, cellular phone, cellular telephone, cell telephone, or other electronic device used for mobile voice or data communication over a network of base stations. Although in the following description, communication is described in certain embodiments using an example of cellular communication, particularly, global system for mobile communication (GSM), it will be understood that the scope of the invention is not limited in this respect, and that the communication method used may be based on any suitable communication protocol, including without limitation, Universal Mobile Telecommunications System (UMTS), IEEE 802.11x, IEEE 802.16x and CDMA. The terms “decrypted” and “decoded” are used interchangeably and have the same meaning throughout this document.

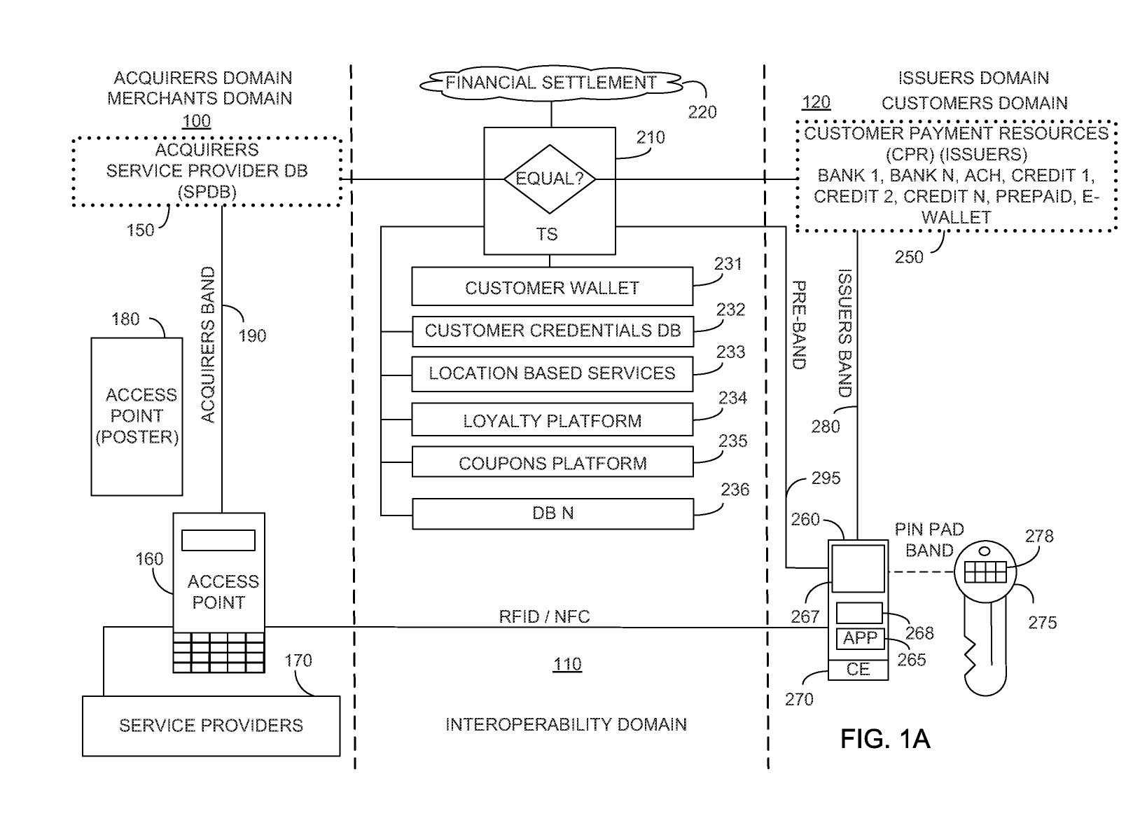

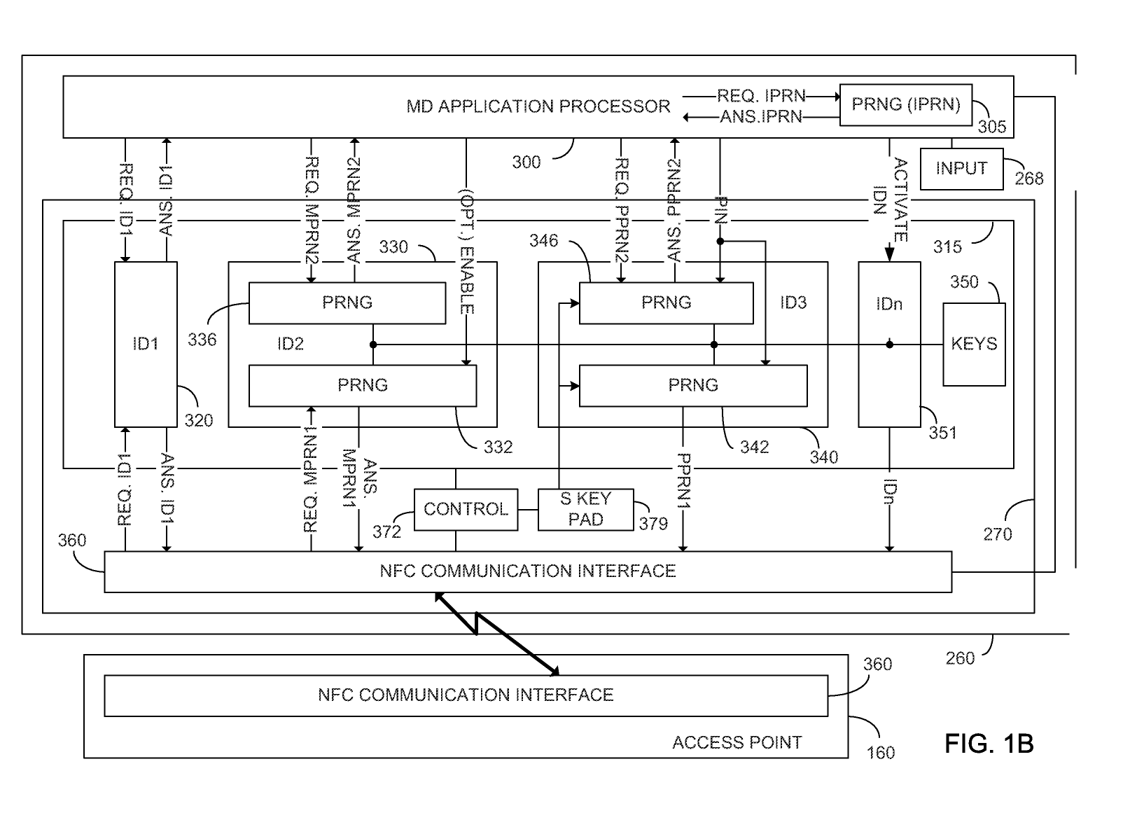

FIG. 1A illustrates a high level block diagram of an advantageous partitioning of certain embodiments of a transaction system arranged to provide improved security for transactions in cooperation with a mobile device. In particular, an acquirers domain 100, also known as merchants domain 100; an interoperability domain 110; and an issuer's domain 120, also known as customer's domain 120 are provided. Advantageously, security information is compartmentalized to prevent fraud.

Acquirer's domain 100 comprises an acquirer 150, comprising a service provider database (SPDB), containing information about the service providers associated therewith; an access point 160; a service provider 170; and an access point poster or tag 180. Access point poster or tag 180 is also known as a check point poster. Access point 160 is also known as a check point 160. While a single acquirer, or a database of a single acquirer 150, access point 160, service provider 170 and access point poster/tag 180 are illustrated this is not meant to be limiting in any way and a plurality of any or all of acquirers 150, or acquirer databases, access points 160, service providers 170 and access point posters/tags 180 may be provided without exceeding the scope. The SPDB of acquirer 150 is in communication with access point 160 with a controlled communication path denoted acquirer's band 190. Access point 160 may be a cash register, check out location, controlled point or entry, without exceeding the scope. Access point 160 may be further implemented as a web server as will be described further below, without exceeding the scope.

Interoperability domain 110 comprises: a transaction server (TS) 210; a financial settlement functionality 220; and a plurality of databases/functionality servers, wherein particularly illustrated are a customer wallet functionality 231, customer credential 232, location based services 233, loyalty platform 234, coupons platform 235 and other databases 236. Financial settlement functionality 220, represented by a cloud, may comprise any, or all of, a brand's functionality, a hub functionality and an automated clearinghouse functionality, without exceeding the scope. TS 210 is in communication with each of financial settlement functionality 220, customer wallet functionality 231, customer credential 232, location based services 233, loyalty platform 234, coupons platform 235 and other databases 236. TS 210 is further in communication with the SPDB of acquirer 150. Customer wallet functionality may be implemented within TS 210 without exceeding the scope, and may particularly implement an electronic wallet as known to those skilled in the art. Advantageously, as will be described below, the electronic wallet is provided herein with added functionality.

Issuer's domain 120 comprises customer's payment resources 250, i.e. issuers of payment options and devices, and a MD 260 comprising a CE 270 and running an application 265 on a processor thereof, application 265 stored on a memory associated with MD 260. MD 260 comprises a display device 267 for displaying information to a user, and an input device 268 for receiving input from a user. Customer's payment resources 250 represents various card issuers, both debit and credit, as well as prepaid cards and e-wallets, without limitation. Customer's payment resources 250 are in communication with MD 260 via an issuer's controlled communication band 280. MD 260, particularly CE 270, is in NFC or RFID communication with access point 160, which in one embodiment represents a provider access device (PAD). Customer's payment resources are further in communication with TS 210. MD 260 is further in communication with TS 210, over a network, denoted pre-band 295, which in embodiment is implemented via a cellular network, without limitation. Optionally, as will be described below, an additional secure device 275 is provided, having an input device 278, such as a keypad, thereon.

FIG. 1B illustrates a high level architecture of MD 260, having embedded thereon CE 270, wherein CE 270 is in communication with access point 160. In particular, MD 260 comprises an MD application processor 300; an MD input device 268 and CE 270. MD application processor 300 comprises a PRN generator 305 and is in communication with CE 270 as will be described in further detail below. Access point 160 comprises an NFC communication interface 360.

CE 270 comprises a secured element (SE) 315; a control circuitry 372; a secured key pad 379; and an NFC communication interface 360. SE 315 comprises: a secured ID1 storage functionality 320; a secured ID2 PRN generator functionally 330; a secured ID3 PRN generator functionality 340; one or more secured IDn storage functionalities 351; and a secured keys storage 350. Secured ID2 PRN generator functionality 330 comprises an NFC associated ID2 PRN generator functionality 332 and an MD associated ID2 PRN generator functionality 336, which may be implemented as two functions of a single PRN generator functionality. Secured ID3 storage functionality 340 comprises an NFC associated ID3 PRN generator functionality 342 and an MD associated ID3 PRN generator functionality 346 which may be implemented as two functions of a single PRN generator functionality. Each of NFC associated ID2 PRN generator functionality 332, MD associated ID2 PRN generator functionality 336, NFC associated ID3 PRN generator functionality 342 and MD associated ID3 PRN generator functionality 346 is arranged to generate a pseudo-random number responsive to one or more keys securely stored on secured keys storage 350. NFC communication interface 360 of MD 260 is in communication with MD processor 300 and is further arranged to be in near field communication with an external NFC communication interface 360, which in one embodiment is embedded within access point 160. Each secured IDn storage functionality 351 is arranged to transmit a respective ID to NFC communication interface 360 of MD 260 responsive to a request received by the respective IDn storage functionality 351 from MD application processor 300. Advantageously, the respective IDn is not transmitted to MD application processor 300. Secured key pad 379 is in communication with control circuitry 372, with ID3 PRN generator functionality 342 and with MD associated ID3 PRN generator functionality 346. Control circuitry 372 is in communication with SE 315 and NFC communication interface 360.

NFC communication interface 360 of access point 160 communicates with NFC communication interface 360 of access point 160 when the various NFC communication interfaces 360 are juxtaposed with each other within a pre-determined range. In one embodiment the pre-determined range is about 4 cm.

In operation, and as will be described further below, secured ID1 storage functionality 320 is arranged to respond to identification requests from either MD application processor 300 or from access point 160 received via NFC communication interface 360 of MD 260, with identification information, denoted herein as ID1. Such identification information preferably comprises an address of MD 260, such as an MSISDN, or other identifier which is translatable by a transaction server, such as TS 210 to an address, i.e. MD 260 is addressable by TS 210 over network 295 responsive to ID1. Secured ID1 storage functionality 320 may be read by MD application processor 300.

NFC associated ID2 PRN generator functionality 332 is arranged to be in communication with NFC communication interface 360, and is responsive to a request for a machine generated PRN, denoted MPRN1, to generate a PRN responsive to one or more keys stored on keys storage 350 and respond with a generated MPRN1. Advantageously, and as described above, the keys stored on keys storage 350 are preregistered with TS 210, and are decipherable by TS 210 to verify the authenticity of MPRN1. It is to be noted that MD application processor 300 is preferably unable to obtain MPRN1 from NFC associated ID2 PRN generator functionality 332. Optionally, NFC associated ID2 PRN generator functionality 332 may be disabled responsive to MD application processor 300 so as to prevent release of MPRN1 without authorization.

MD associated ID2 PRN generator functionality 336 is arranged to be in communication with MD application processor 300, and is responsive to a request for a machine generated PRN, denoted MPRN2, to generate a PRN responsive to one or more keys stored on keys storage 350 and respond with a generated MPRN2. Advantageously, and as described above, the keys stored on keys storage 350 are preregistered with TS 210, and are decipherable by TS 210 to verify the authenticity of MPRN2. Preferably MPRN2 is distinguished from MPRN1 and may be encoded with different keys stored on keys storage 350 without exceeding the scope.

NFC associated ID3 PRN generator functionality 342 is arranged to be in communication with NFC communication interface 360, and is responsive to a personal information number (PIN) provided from MD application processor 300 to generate a PRN responsive to one or more keys stored on keys storage 350, and to respond with a generated PIN supported PRN, denoted PPRN1. In one embodiment, the PIN is first verified by SE 315, in one embodiment by utilizing a PIN verification value (PVV) calculated by control circuitry 372. Advantageously, and as described above, the keys stored on keys storage 350 are preregistered with TS 210, and are decipherable by TS 210 to verify the authenticity of PPRN1. It is to be noted that MD application processor 300 is preferably unable to obtain PPRN1 from NFC associated ID3 PRN generator functionality 342. It is to be noted that in the absence of a PIN provided from MD application processor 300, NFC associated ID3 PRN generator functionality 342 does not generate PPRN1. Alternatively, an ID2 is provided to access point 160 which has at least field indicative that no PIN was supplied for generation of the ID3.

The term PIN as used herein is not meant to be limited to a number or string of number, and an alphanumeric string may be utilized without limitation, including non-alphabetic characters and spaces, without exceeding the scope.

MD associated ID3 PRN generator functionality 346 is arranged to be in communication with MD application processor 300, and is responsive to a request for a PIN supported PRN, denoted PPRN2, to generate a PRN responsive to one or more keys stored on keys storage 350, and to a PIN received from MD application processor 300 to respond with a generated PPRN2. Advantageously, and as described above, the keys stored on keys storage 350 are preregistered with TS 210, and are decipherable by TS 210 to verify the authenticity of PPRN2. Preferably PPRN2 is distinguished from PPRN1 and may be encoded with different keys stored on keys storage 350 without exceeding the scope. There is no requirement that each of PPRN1, PPRN2, MMPRN1 and MMRPN2 be supported in each embodiment, and in particular in certain embodiment PPRN2 and MMPRN2, and the associated generating functionalities are not supplied.

MD application processor 300 is optionally further provided with an internal PRN (IPRN) generator 305, which is preferably utilized in the absence of CE 270 or in the event that the various PRN generator functionalities 332, 336, 342 and 346 are not able to be loaded onto SE 315 as will be described further below. The generated PRN of internal PRN generator 305 is denoted herein as IPRN.

Secured keypad 379 prevents key logging theft by malicious software loaded onto MD application processor 300 since it is not involved in other data entry operations, and thus is preferably immune to key logging software. In one embodiment, secured keypad 379 is internally hardware encoded to output a resultant PIN to secured ID3 storage functionality 340 without utilizing software susceptible to key logging.

The above has been described in an embodiment wherein various PRN generators are provided within SE 315. In an alternative optional embodiment, as shown in FIG. 1A, a separate secure device 275 is provided, with an input device 278, such as a keypad. Secure device 275 comprises an NFC communication interface 360 (not shown) arranged to communication with NFC communication interface 360 of MD 260 when juxtaposed therewith. Secure device 275 is juxtaposed with NFC communication interface 360 of MD 260, a PIN is entered onto entry device 278, and responsive thereto PPRN1 is generated and transmitted to MD 260 via the embedded NFC communication interface 360 and NFC communication interface 360 of MD 260. MD 260 is arranged to receive the generated PPRN1 and forward PPRN1 as if it was internally generated. Such a separate key system adds additional security, since PPRN1 is not physically generated within MD 260. Alternatively, a PIN entered on secure device 275 activates PRN generator functionality 342 of SE 315. In such an embodiment PPRN1 is generated and transmitted to access point 160 when CE 270 is juxtaposed with access point 160.

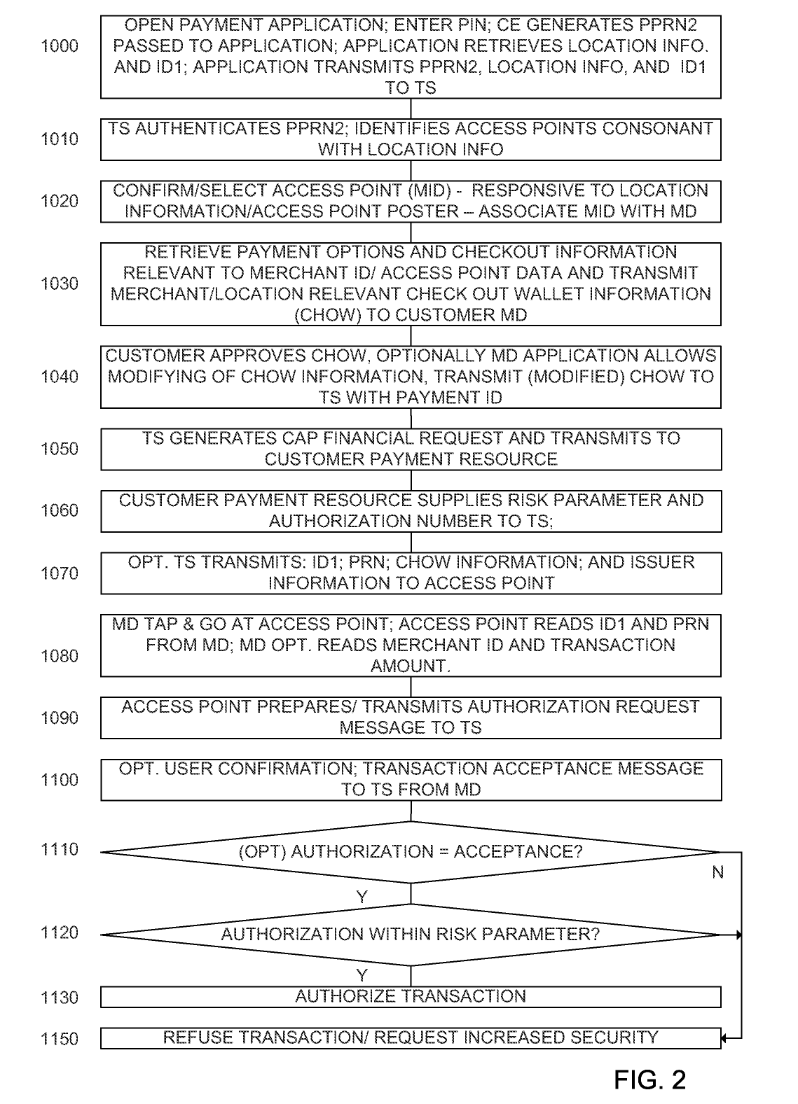

FIG. 2 illustrates a transaction flow utilizing the various domains of FIG. 1A in cooperation with the architecture of FIG. 1B, FIGS. 1A, 1B and 2 being described herein together for ease of understanding. Advantageously, TS 210 is arranged to provide MD 260 with relevant checkout information, while maintaining security and fraud control.

In stage 1000, a user opens payment application 265 running on a processor of MD 260 and enters a PIN which has been preregistered with TS 210. Payment application 265, in cooperation with SE 315, and in particular in cooperation with MD associated ID3 PRN generator functionality 346, responds to a request from MD application processor 300 responsive to payment application 265 with PPRN2 responsive to a PRN key which was initially loaded at registration, and preferably stored in secured keys location 350. MD 260 further retrieves from secured ID1 storage functionality 320 ID1. Application 265 further retrieves location information, as will be described below, and transmits to TS 210 the generated PPRN2, location information and ID1. As described above, ID1 preferably represents a readable ID of CE 270. Location information may be generated by one or both of on board GPS electronics, or responsive to base station transmission calculations. The readable ID of CE 270 received from secured ID1 storage functionality 320 may be directly transferred, or an encoded identifier may be utilized without exceeding the scope. The readable ID of CE 270 is denoted ID1, for ease of identification, and in one embodiment is a readable identifier of MD 260.

In stage 1010, responsive to the received transmission of stage 1000, TS 210 authenticates the received PPRN2 responsive to keys stored thereon. In the event that TS 210 fails to authenticate the received message, no further action is taken (not shown), or alternately a fail message is returned to application 265. TS 210 further identifies the access points 160 in geographic proximity to MD 260 responsive to the received location information, i.e. TS 210 determines the registered access points 160 whose locations are consonant with the location of MD 260. The term consonant with, as used in the context of location information, and as used herein, does not require an exact location match, but instead is indicative of a location match within a pre-determined range, which preferably takes into account location determining errors, the amount of which errors may be further location dependent.

In stage 1020 a merchant ID (MID) is identified and associated with MD 260. In the event that only a single access point 160 registered with TS 210 exhibits a location consonant with the received location information, TS 210 transmits the name of the identified access point 160 to MD 260 for confirmation. In the event that a plurality of access points 160 are consonant with the received location information, for example in a mall, a list of registered access points 160 with consonant location information is transmitted to MD 260, and the appropriate merchant, i.e. the appropriate access point 160, wherein MD 260 is currently located and for which the user of MD 260 wishes to consummate a transaction is selected responsive to a user gesture on input device 268 of MD 260 and the selection is transmitted to TS 210 as the merchant ID.

Alternatively, an access point poster 180, arranged to transmit a merchant ID is provided, and MD 260 reads the merchant ID from access point poster 180 by juxtaposing MD 260 with access point poster 180. Advantageously, in place of a pointer of the prior art, MD 260 is arranged to transmit the read MID from access point poster 180 to TS 210 thus providing location information for MD 260 and other useful information regarding the merchant specific ID to TS 210.

Alternatively, access point poster 180 may be arranged to read ID1 of CE 270 via the respective NFC communication interfaces 360. In such an embodiment, access point poster 180 transmits read identifier ID1 of CE 270 to TS 210 along with self identifying information, thus providing TS 210 with location based information regarding MD 260 since the location of access point poster 180 is pre-registered with TS 210. In summary, an MID is obtained responsive to the juxtaposition of MD 260 with a particular area on access point poster 180, or responsive to location information of stage 1000, or responsive to a user input from a provided list of merchants, which are selected responsive to location information. Advantageously, the MID obtained represents an intended transaction location/merchant for the user of MD 260, and is now associated with MD 260 until a transaction is completed, a different merchant ID is obtained, or a predetermined time period has expired.

In stage 1030, the obtained MID of stage 1020 associated with MD 260 is transmitted to the various databases 231-236, to determine if any promotions, loyalty benefits, pre-purchase coupons, or gift certificates, without limitation, for the associated obtained MID of stage 1020 are relevant to MD 260. Similarly, information regarding payment options for the identified access point 160 is determined, and the relevance to the customer's wallet is retrieved from customer wallet functionality 231. For example, only certain payment options may be accepted by identified access point 160, and a nexus of accepted payment options and available payment options from customer wallet functionality 231 is determined. Any relevant coupons retrieved from customer wallet functionality 231 and/or coupons platform 235 may be optionally validated by the issuer, if required. Check Out Wallet (CHOW) information is generated by TS 210 and transmitted to MD 260, the CHOW information being advantageously defined in relation to the obtained MID and is thus location relevant, exhibiting only offers, discounts or payment options relevant to the merchant which has been associated with MD 260 as described in stage 1020.

In optional stage 1040, MD 260 may modify the received CHOW information, responsive to a user gesture in relation to input device 268 of MD 260, particularly selecting from among various payment options and/or agreeing to utilize one or more benefits offered. Any CHOW based selections, as modified, are transmitted to TS 210, or alternatively only modifications are transmitted to TS 210. It is to be noted that all of the above mentioned communication between MD 260 and TS 210 has preferably been accomplished exclusively along pre-band 295 which is secured, in one embodiment by a secure sockets layer (SSL). The CHOW information preferably includes an identifier of the desired payment method of the user of MD 260, shown as a payment ID.

In stage 1050, TS 210, responsive to the received CHOW based selections, or simple CHOW approval, of stage 1040, generates a cap financial transaction request from an issuer within customer's payment resources 250. The cap financial request preferably comprises the initially generated PPRN2, the selected payment ID and an identifier of access point 160, and ID1. Alternatively, a newly generated authenticated PRN is utilized in place of PPRN2.

In stage 1060, the issuer, or other payment resource, calculates a risk parameter, and generates an authorization number. The risk parameter typically comprises a financial transaction limit, below which no further authorization is required. In one embodiment, the risk information is generated responsive to the received PRN or PPRN2. This communication is preferably performed solely between TS 210 and customer payment resources 250.

In stage 1070, responsive to the received authorization number, TS 210 optionally generates a message for transmission to access point 160 associated with MD 260 of stage 1020 comprising: ID1, the modified CHOW information and an identifier of the issuer.

In stage 1080, after the user associated with MD 260 has determined the ultimate desired transaction, and preferably a PIN has been entered via input device 268 of MD 260, CE 270 is juxtaposed with access point 160, in a process known as Tap and Go, which limits the juxtaposed time to a predetermined minimum. Access point 160 reads ID1 and PPRN1 from CE 270 and MD 260 optionally reads the MID of access point 160 and the transaction amount. In particular, access point 160 optionally calculates the amount left to be paid of the transaction after deducting any CHOW based credits. PPRN1 is read responsive to the input PIN. In another embodiment MPRN1 is read and thus a PIN is not required to be entered via input device 268 into MD 260.

In stage 1090, responsive to the read ID1, access point 160 prepares an authorization request message to conclude the transaction, the authorization request message being transmitted to TS 210. The authorization request message is generated preferably comprising: ID1 read during the Tap and Go procedure of stage 1080; PPRN1 read during the tap and go procedure of stage 1080; the MID for access point 160; any loyalty, coupons, gift card or other CHOW based discounts; the amount; and a transaction identifier. As described above, the authorization request message generated by access point 160 is transmitted by access point 160 via provider's band 190 to acquirer 150, and acquirer 150 transmits an authorization request message to TS 210. In one embodiment, the loyalty and coupon information is transmitted directly to TS 210 from access point 160.

In optional stage 1100, MD 260, particularly application 265, presents a confirmation message for acceptance by a user, preferably requiring input of a code, such as PIN for authorization. Responsive to an acceptance gesture, and/or code input, via input device 268, MD 260 transmits a transaction acceptance message to TS 210 comprising ID1, PPRN2, read access point 160 identifier, and the amount. Optionally, a payment identifier is further transmitted to MD 260 in the Tap and Go procedure of stage 1080 and provided as part of the transaction acceptance message. In one embodiment, a subset of the above information is transmitted so as not to exceed the time limit of the Tap and Go.

TS 210 thus receives an authorization request message generated by access point 160 in stage 1090 and optionally a transaction acceptance message generated by MD 260 in stage 1100. In optional stage 1110, the elements of the received authorization request message of stage 1090 are compared with the transaction acceptance message match of stage 1100, and in the event that they match, i.e. the messages ID1, access point 160 identifier, payment ID and amount match, and PPRN1 points to the same device address as PPRN2, in stage 1120 TS 210 compares the transaction amount of the authorization request message of state 1090 with the received risk parameter of stage 1060.

As described above, PPRN1 and PPRN2 are generated as part of SE 315 from a set of keys stored on secured keys storage 350. Deciphering of PPRN1 and PPRN2 is advantageously accomplished by TS 210 responsive to key information, and reveals a singular identifier, or a pair of identifiers which are stored as being equivalent on a database accessible by TS 210. In the event that in stage 1110 the messages do not match, an error condition is flagged and the transaction is not completed as shown in stage 1150.

In the event that in stage 1120 the transaction amount is less than that approved by the received risk information, in stage 1130 the transaction is authorized by TS 210. The authorization number received from the issuer by TS 210 in stage 1060 is transmitted to access point 160 via acquirer 150 through acquirer band 190. A transaction confirmation message is similarly transmitted by TS 210 to customer payment resources 250, e.g. to an issuer, comprising: ID1; the PRN agreed between TS 210 and the issuer; and the amount for settlement. Optionally, one of PPRN1 and PPRN2 is further transmitted to the issuer confirming that a PIN has been received as part of the transaction. Any gift, coupon or loyalty information is similarly transmitted to the respective database/server. A transaction approval message is transmitted to MD 260 by TS 210, optionally the transaction approval message includes further local relevant information, such as promotions by adjacent vendors.

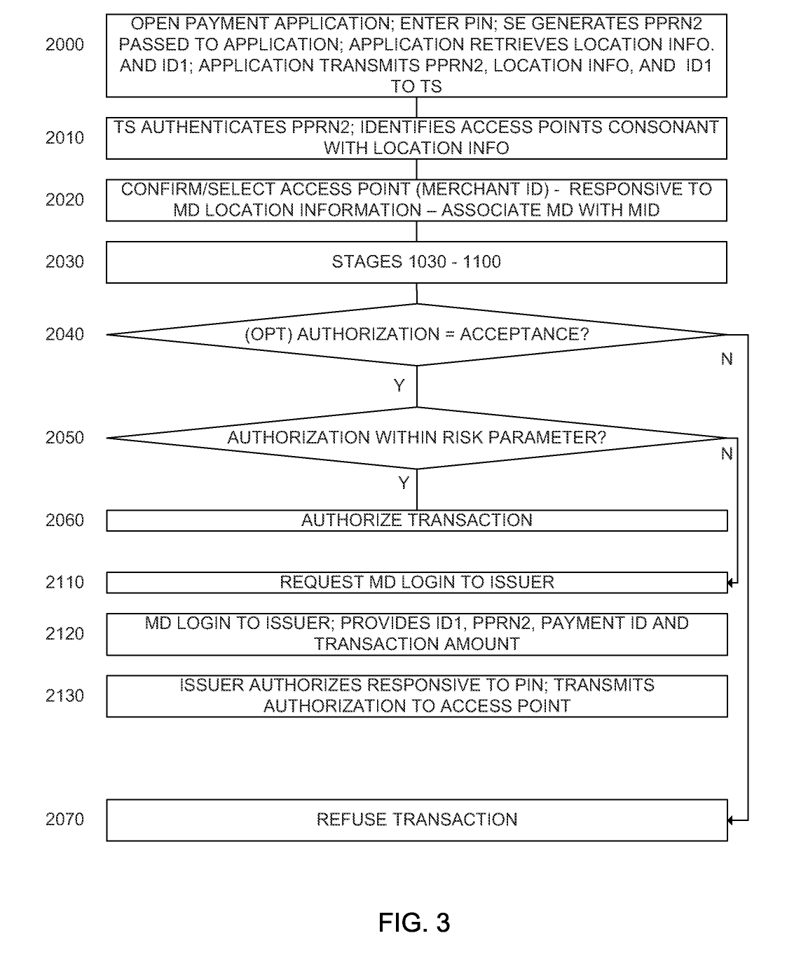

In one embodiment however, as shown, in the event that in stage 1120 the transaction amount is greater than that approved by the received risk information, or in the event that in optional stage 1110 elements of the received authorization request message of stage 1090 do not math the transaction acceptance message match of stage 1100 in stage 1150 the transaction is refused or increased security is required as will be described further below in relation to FIG. 3.

Thus, by the utilization of the server based architecture described herein, location based promotions and transaction completion may be advantageously accomplished, providing relevant check out information. In particular, the check out information is relevant to the actual merchant associated with MD 260 and for which a transaction is to be pending.

FIG. 3 illustrates a transaction flow utilizing the various domains of FIG. 1A in the absence of access point poster 180, and further requiring an additional authorization in the event that the amount exceeds the cap amount determined by the received risk information. Thus, the transaction flow is in all respects similar to that of FIG. 2, described above, except as detailed herein.

Stage 2000-2020 are thus in all respects identical with stages 1000-1020 described above, respectively, however in the absence of access point poster 180, location information is in one embodiment supplied responsive to one or both of MD 260 GPS electronics or responsive to base station transmission calculations. Thus, TS 210 obtains location information either from the cellular network handling MD 260 or from MD 260, without limitation. In yet another embodiment, where GPS functionality is not available in MD 260, application 265 obtains location information from the network and transmits the obtained location information to TS 210. Thus, in stage 2010-2020, in the event that a singular access point 160 cannot be determined, a list of possible registered suppliers, i.e. access points 160 whose location are consonant with the obtained location of MD 260 are transmitted to MD 260 by TS 210, and a selected supplier is returned to TS 210 by MD 260 and the MID of the selected access point 160 is associated with MD 260.

Stage 2030 represents stages 1030-1100 of FIG. 2, and the interest of brevity will not be further described.

Stage 2040 is in all respects identical to stage 1110 of FIG. 2. In the event that in stage 2040 the messages do not match, an error condition is flagged and the transaction is not completed as shown in stage 2070. In the event that in stage 2040 the messages do match, in stage 2050 TS 210 compares the transaction amount of the authorization request message of state 1090 with the received risk parameter of stage 1060. In the event that the transaction amount is less than that approved by the received risk information, in stage 2060 the transaction is authorized by TS 210.

In the event that in stage 2040 the transaction amount is greater than that approved by the received risk information, in on embodiment (not shown) TS 210 requests authorization from the issuer. In another embodiment, as illustrated by stage 2110, a message is transmitted from TS 210 to MD 260, requesting that the user of MD 260 log into the issuer/user domain. In stage 2120 MD 260 logs into the directed issuer web page and transmits ID1, PPRN2, the payment ID and the transaction amount. In stage 2130 the issuer web page may authorize the transaction, but typically will require some identification, such as a PIN related to the specific chosen payment ID or other restricted information to reduce the risk. Upon receipt of the additional information, and in the event that the issuer agrees to authorize the transaction, an authorization message, including: an authorization number; ID1; the PRN agreed between TS 210 and the issuer; the payment ID; and the transaction amount, is transmitted directly to TS 210. Transaction approval is finalized as described above in relation to FIG. 2.

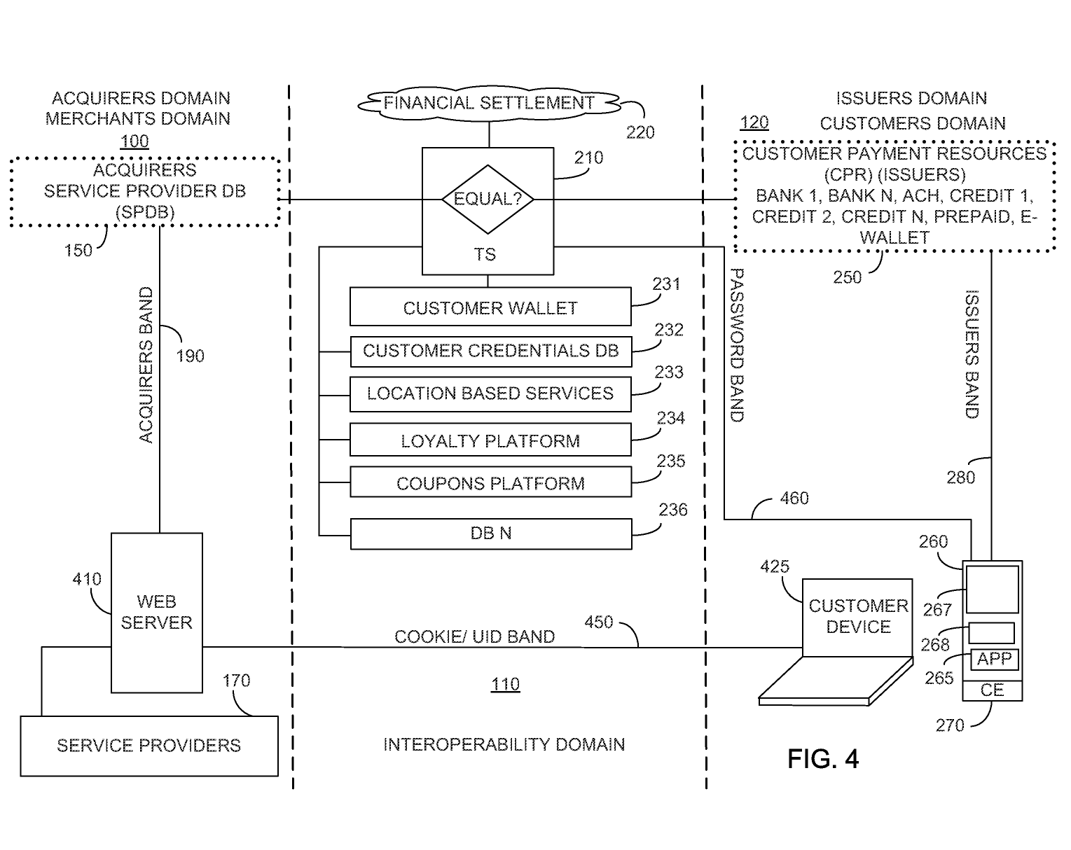

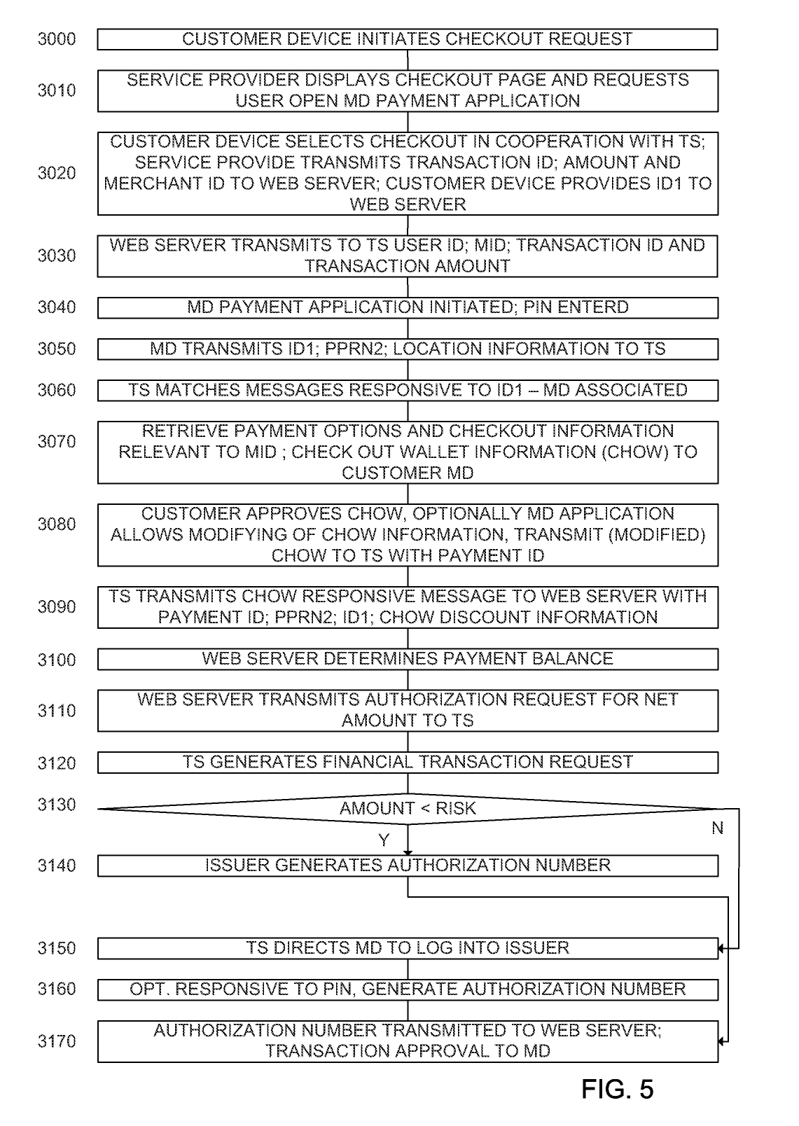

FIG. 4 illustrates a high level block diagram of an embodiment of the arrangement of FIG. 1A, wherein access point 160 is replaced by a web server 410. An additional customer device 425, such as a computer is further provided, customer device 425 in communication with web server 410 over a network 450 such as the Internet, network 450 also denoted cookie/UID band 450. MD 260 is in communication with TS 210 via a network, such as a cellular network, denoted password band 460. All other elements in FIG. 4 are substantially identical with those of FIG. 1A, and thus in the interest of brevity will not be further detailed. FIG. 5 illustrates a transaction flow utilizing the various domains of FIG. 4, FIGS. 4 and 5 being described herein together for ease of understanding.

In stage 3000, customer device 425 is desirous of purchasing a product or service from web based service provider 170 and initiates a checkout request. In stage 3010, web based service provider 170 provides customer device 425 with a checkout page and preferably further requests that the customer open payment application 265 on MD 260. In stage 3020 customer device 425 selects checkout in cooperation with TS 210 from among the various options, and web based service provider 170 transmits a transaction ID, amount and merchant ID to web server 410. Customer device 425 preferably provides a user ID stored on a cookie to web server 410. In one embodiment, the user ID is ID1 of MD 260, which has been sent to customer device 425 when registered with TS 210. In one embodiment, the user ID is the MSISDN of MD 260 and is thus easily entered via an input device of user device 425.

In stage 3030, web server 410 transmits a message to TS 210, via acquirer 150, including the obtained user ID, web server or MID, a transaction ID generated by web server 410 and the transaction amount.

In stage 3040, responsive to the opening of application 265 of stage 3010, MD 260 initiates a payment transaction function of application 265, and selects web based transactions. A PIN or other code preregistered with TS 210 is entered into MD 260 to enable the generation of PPRN2 as described below.

In stage 3050, MD 260 creates and transmits a message to TS 210 comprising ID1, i.e. a readable identifier of CE 270; PPRN2; and location information. In one embodiment, location information is generated responsive to one or both of on board GPS electronics and base station transmission calculations. In one embodiment, location information is optional.

In stage 3060, TS 210 matches the received message from MD 260 of stage 3050 with the received transaction message from web server 410 of stage 3030 responsive to consonance of ID1 with the user ID. In one embodiment, as described above, the provided user ID is the same as ID1 and in another embodiment the provided user ID is uniquely cross referenced with ID1, i.e. with the readable identifier of CE 270 in a database accessible by TS 270 such as customer credentials DB 232. MD 260 is therefore associated with web server 410 for the purposes of a transaction.

In stage 3070 TS 210 retrieves data from the various databases 231-236 to determine if any promotions, loyalty benefits, pre-purchase coupons, or gift certificates, without limitation, are relevant to the customer in relation to web server 410.

Similarly, information regarding payment options for the web server 410 is determined, and the relevance to the customer's wallet is retrieved from customer wallet functionality 231. Any relevant coupons retrieved from coupons platform 235 may be optionally validated by the issuer. CHOW information is generated by TS 210 and transmitted to MD 260, and information responsive thereto is displayed on display device 267. Advantageously, the CHOW information is relevant to web server 410, exhibiting only offers, discounts or payment options relevant to MD 260 in relation to web server 410 and/or web service provider 170 and any associated links. In one embodiment, a subset of the CHOW information is transmitted to, and displayed on, customer device 425.

In optional stage 3080, a user of MD 260 may modify the received CHOW, particularly selecting from among various payment options and/or agreeing to utilize one or more benefits offered, via a user gesture in relation to input device 268 of MD 260. The CHOW further comprises the payment amount information as initially received from web server 410. Information regarding any CHOW based selections are transmitted to TS 210 in cooperation with a payment ID.

In stage 3090, TS 210 prepares and transmits a CHOW responsive message to web server 410 comprising the payment ID received from MD 260, PPRN2 generated by MD 260, ID1 of MD 260, or a code translatable thereto, and any discount information such as loyalty, coupons and gift card information.

In stage 3100, web server 410, responsive to the received message from TS 210 of stage 3090 determines a payment balance for web based service provider 170, and obtains acknowledgement/approval therefrom. In stage 3110, web server 410, responsive to the received acknowledgement/approval transmits an authorization request with a net amount to TS 210.

In stage 3120 TS 210 generates a financial transaction request from an issuer within customer's payment resources 1350, responsive to the payment ID. The financial transaction request preferably comprises the above mentioned ID1, the initially generated PPRN2, the selected means of payment ID, the MID and the amount.

In stage 3130 the issuer, or other payment resource, calculates a risk parameter, and if the transaction amount is less than a predetermined risk value generates an authorization number in stage 3140.

In the event that the transaction amount is in excess of the predetermined risk value, in stage 3150 TS 210 communicates with MD 260 to direct a user of MD 260 to log onto the issuer/customer domain so as to obtain authorization. MD 260 logs into the directed issuer web page and transmits ID1, the PPRN2, the means of payment ID and the transaction amount. In stage 3160 the issuer web page may authorize the transaction, but typically will require some identification, such as a PIN or other restricted information to reduce the risk. Upon receipt of the additional information, and in the event that the issuer agrees to authorize the transaction, an authorization message including an authorization number, ID1, PPRN2, the payment ID and the transaction amount is transmitted directly to TS 210.

In stage 3170, the authorization number received by TS 210 is transmitted to web server 410 via acquirer 150 through acquirers band 190. Any gift, coupon or loyalty information is similarly transmitted to the respective database/server. A transaction approval message is transmitted to MD 260 by TS 210, optionally including further local relevant information, such as promotions by adjacent vendors responsive to the initial location information, or other related web servers 410.

In the event that in stage 3140 the issuer has generated an authorization number, stage 3170 is similarly performed.

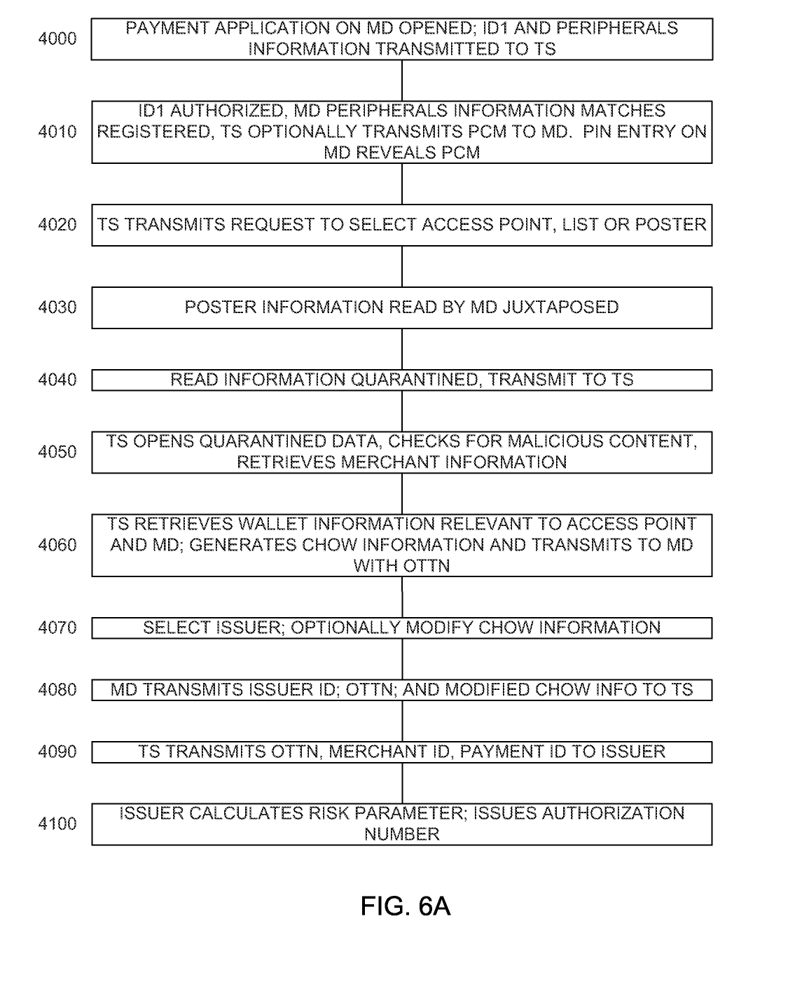

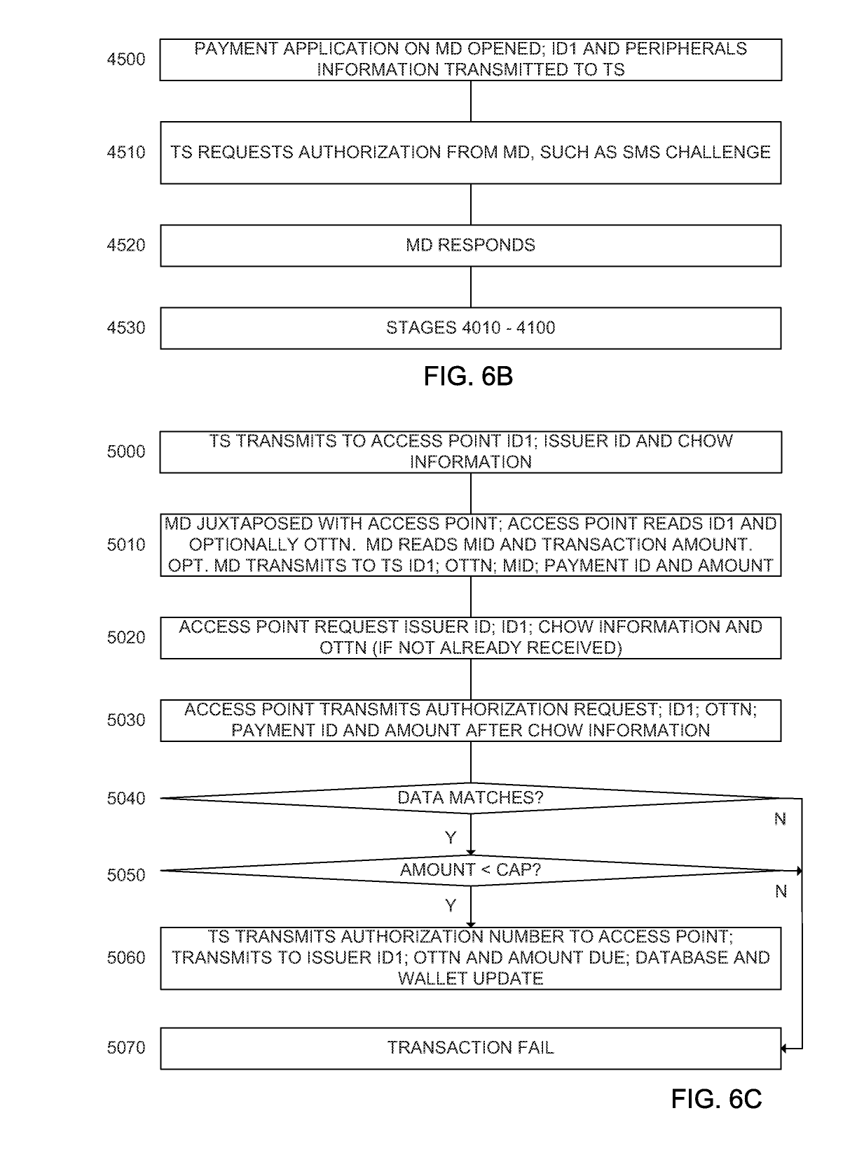

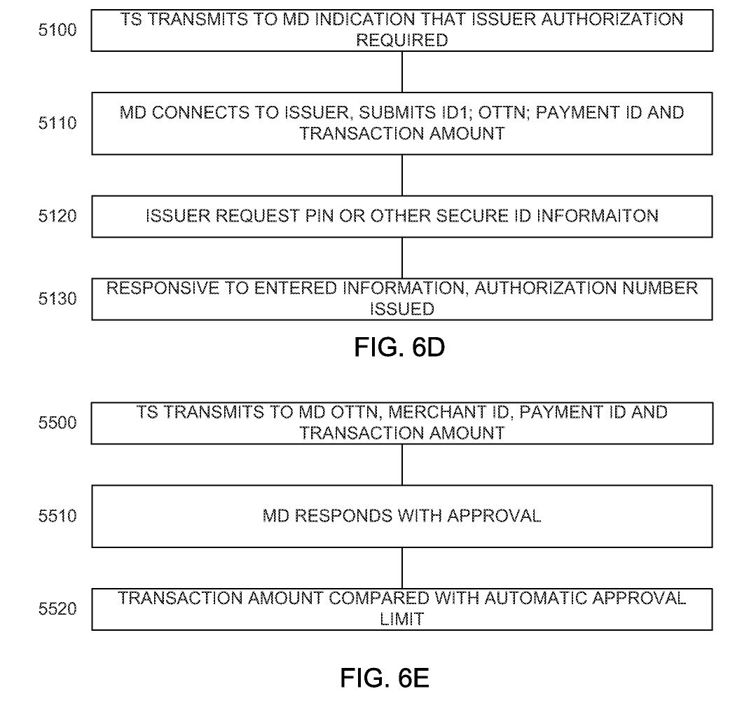

FIG. 6A illustrates a transaction flow utilizing the various domains of FIG. 1A, wherein TS 310 acts as a remote firewall for MD 260 in relation to access point poster 180.

In stage 4000 a user opens payment application 265 on MD 260 and MD 260 communicates with TS 210. In one embodiment, MD 260 communicates with TS 210 via a wireless network utilizing General Packet Radio Service (GPRS) and in another embodiment via a wireless network utilizing an IEEE 802.11 standard, such as WiFi via pre-band 295 or password band 460 of FIGS. 1A, 4, respectively. MD 260 transmits to TS 210 information, including: ID1, or a code translatable thereto; MD peripherals identification information stored on a cookie, such as the International Mobile Subscriber Identity (IMSI) of MD 260, the International Mobile Equipment Identity (IMEI) of MD 260 and/or the Bluetooth ID of MD 260; location information which may be generated by one or both of on board GPS electronics, or responsive to base station transmission calculations; and optionally an IP header tagging message, in the event the communication between MD 260 and TS 210 is via GPRS.

In stage 4010, in the event ID1 and the MD peripherals identification information matches information stored on TS 210, TS 210 optionally transmits a personalized confirmation message (PCM) which has been pre-registered with TS 210 and a request for a PIN to MD 260. The customer enters a PIN and preferably, for each section of the PIN entered, a portion of the PCM is displayed on MD 260, thus aiding as anti-phishing detection. In the event the user of MD 260 does not recognize the portion of the PCM being displayed, the user is thus made aware that a phishing attack is taking place and can stop entering the PIN. After completion of entering the PIN, the PIN is transmitted to TS 210.

In stage 4020, TS 210 transmits to MD 260 a request to select an access point 160 from a list, or to juxtapose MD 260 with access point poster 180 so that NFC communication interface 360 of MD 260 is enabled to read an identifier of access point 160 from access point poster 180.

In stage 4030, in the event that MD 260 is juxtaposed with access point poster 180, also known as “tapping”, merchant information such as identifier of access point 160 is received by MD 260 via near field communication. Since access point poster 180 is easy, simple and widely open to malicious attacks, in stage 4040 the received merchant information is quarantined by MD application 265, i.e. not read but only transferred as is, and transmitted to TS 210 which acts as a remote fire wall for MD 260.

In stage 4050 TS 210 opens the quarantined read information and checks for malicious content. If no malicious content is present, in stage 4060 TS 210 retrieves the relevant merchant information of access point 160 and associates MD 260 with the MID responsive to the merchant information. In the event malicious content is found, TS 210 acts to block any transaction or infection.

In stage 4060, TS 210 retrieves from customer wallet functionality 231 information relevant to the merchant of access point 160 in relation to MD 260 such as payment means available to MD 260 which are accepted by access point 160. TS 210 transmits the merchant information to the various databases 232-236 to determine if any promotions, loyalty benefits, pre-purchase coupons, or gift certificates, without limitation, are relevant to the current MD 260 condition, i.e. preparation to engage in commerce with access point 160, and validate current information stored in the customer wallet. Any relevant coupons retrieved from customer wallet functionality 231 and/or coupons platform 235 may be optionally validated by the issuer. CHOW information is generated by TS 210 and transmitted to MD 260, the CHOW information being advantageously defined in relation to the defined access point 160 of stage 4030 and is thus relevant, exhibiting only offers, discounts or payment options relevant to the current merchant MD 260 is associated with. Additionally, a One Time Transaction Number (OTTN) is transmitted to MD 260, the OTTN generated uniquely for the present transaction.

In stage 4070, responsive to an input gesture in relation to input device 268 of MD 260, an issuer is selected from the CHOW selection of stage 4060. In one embodiment, the customer can modify the received CHOW information. In stage 4080 MD 260 transmits the issuer ID, the OTTN and the modified CHOW information to TS 210. Alternately, only information regarding selections made is transmitted. In stage 4090, TS 210 transmits to the selected issuer the ID 1 of stage 4000, the OTTN, the MID and payment ID, such as a transaction number. In stage 4100 the issuer calculates a risk parameter for the customer and optionally an authorization number and transmits them to TS 210. Various failure modes, such as the transaction amount exceeding the risk exist, however these may be handled as described above without exceeding the scope.

FIG. 6B illustrates the transaction flow similar to that of FIG. 6A, where the MD 260 peripheral identification information transmitted to TS 210 by MD 260 does not match information stored on TS 210; or when communication between MD 260 and TS 210 does not allow automatic detection of MD 260 and the customer MD peripheral identification information was not transmitted on a cookie. Such a communication link is exemplified by WiFi, however this is not meant to be limiting in any way.

In stage 4500 responsive to a user gesture in relation to input device 268 payment application 265 is initiated on MD 260 and responsive thereto MD 260 communicates with TS 210. As indicated above, complete information is however not successfully transferred.

In stage 4510, a message is transmitted from TS 210 to MD 260, preferably by SMS, in one embodiment requesting a background authorization from MD 260, i.e. an automatic authorization without user input. In one embodiment, the message comprises an ID number. In another embodiment, where the communication between MD 260 and TS 210 is by GPRS, the MD ID number is transmitted via an IP header tagging message.

In stage 4520, a response is received from MD 260, including the missing information. Stage 4510-4520 may also be used to improve the security level even in the event that full information is initially transferred.

In stage 4530, stages 4010-4100 as described above are performed.

FIG. 6C illustrates a transaction flow for the embodiments of FIGS. 6A-6B, further detailing the transaction flow of stage 4100, wherein an authorization number with auto-approval limit has been received by TS 210.

In stage 5000, TS 210 optionally transmits to access point 160 ID1 of MD 260, the issuer ID and the optionally modified CHOW information. In stage 5010, MD 260 is juxtaposed with access point 160, to initiate a Tap and Go procedure, i.e. reading by each of the respective NFC interfaces 360. ID1 and optionally the OTTN are transmitted to access point 160 by MD 260 via the respective NFC interfaces 360. Access point 160 optionally transmits to MD 260 the MID of access point 160 and the transaction amount, if applicable. Optionally, MD application 265 generates and outputs on display device 267 of MD 260 a message including the MID and the transaction amount and requests authorization. Further optionally, responsive to a customer's acknowledgement via a user gesture in cooperation with input device 268 of MD 260, MD 260 transmits to TS 210 ID1, the OTTN, the MID, the payment ID and the transaction amount variously as read in stage 5010.

In stage 5020, in the event that TS 210 has not transmitted ID1 of MD 260 to access point 160, as well as the issuer ID and the optionally modified CHOW information, access point 160 transmits to TS 210 an information request message and TS 210 responds with the ID1 of MD 260, the generated OTTN, the optionally modified CHOW information and the issuer ID. In stage 5030, responsive to the received information, access point 160 transmits an authorization request message to TS 210. In one embodiment, the authorization request message is accompanied with: ID1; the OTTN; updated loyalty, coupons and gift information relevant to MD 260; the payment ID; and the transaction amount due.

In stage 5040, TS 210 compares the received data from access point 160 to the optionally received data from MD 260. In the event that the received data from both of access point 160 and MD 260 match, in stage 5050 TS 210 compares the amount due to the risk information received from the issuer. In the event that in stage 5050 the amount due is within a cap amount determined by the risk information, in stage 5060 TS 210 transmits the authorization received from the issuer to access point 160. Additionally, TS 210 transmits to the issuer ID1, the OTTN and the transaction amount due. In addition, TS 210 transmits to the various databases 231-236 the updated loyalty, gift and coupon information. Preferably, the customer wallet stored on customer wallet functionality 231 is then updated by TS 210. In stage 5070, TS 210 transmits to MD 260 a transaction approval message and preferably useful local information, such as the location of other merchants.

In the event that in stage 5040 the received data from both of access point 160 and MD 260 does not match, or in the event that in stage 5050 the amount due exceeds the cap amount determined by the risk information, in stage 5070 the transaction fails.

FIG. 6D illustrates the transaction flow of FIG. 6C, in the event that the transaction amount is greater than the amount authorized by the issuer, however without immediately implementing stage 5070. In stage 5100, in the event that in stage 5050 the amount due exceeds the cap amount determined by the risk information, TS 210 transmits to MD 260 a message stating that issuer authorization is necessary.

In stage 5110, MD 260 connects to the issuer via customer band 280 and transmits the relevant information, i.e. ID1, the OTTN, the payment ID and the transaction amount. In stage 5120, the issuer requests from MD 260 to enter a PIN or other secure ID information. In stage 5130, responsive to entered relevant information, the issuer transmits to TS 210 an authorization number.

FIG. 6E illustrates the transaction flow of FIG. 6D, in the event that TS 210 requests approval from MD 260 after receiving an authorization request message from access point 160. In stage 5500, TS 210 transmits to MD 260 the OTTN, the merchant ID, the payment ID and the transaction amount. In stage 5510, MD 260 replies with the received information approval, responsive to a user input. In stage 5520, the transaction amount is compared to an amount automatically approved by the issuer, as described above in relation to the transaction flows of FIGS. 6C and 6D, and in the interest of brevity not further described.

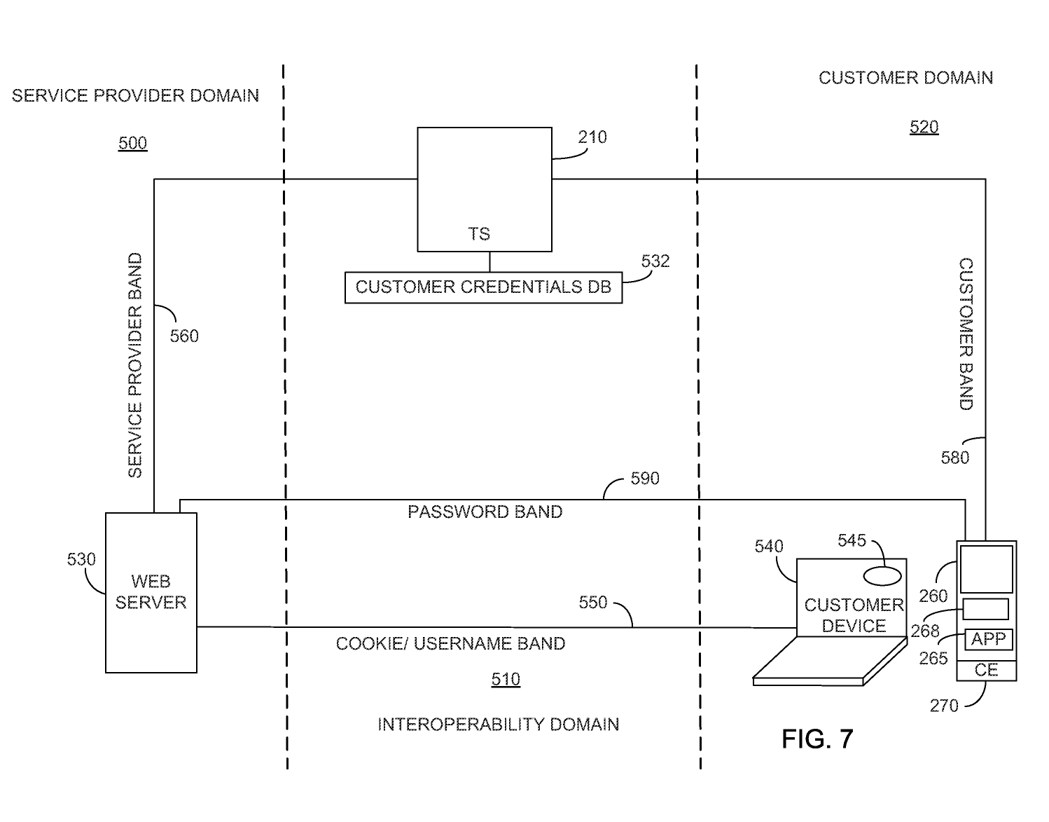

FIG. 7 illustrates a high level block diagram of advantageous partitioning of certain embodiments allowing for web out of band login (OOBL). In particular, a service provider domain 500; an interoperability domain 510; and a customer domain 520 are provided. Advantageously, security information is compartmentalized to prevent fraud.

Service provider domain 500 comprises a service provider web server 530, which as will be understood is a particular embodiment of access point 160 as described above. Interoperability domain 510 comprises a TS 210 and a customer credential database 532, in communication with each other. Customer domain 520 comprises: a customer device 540, illustrated without limitation as a portable computer; and an MD 260, comprising a CE 270. MD 260 has loaded thereon an application 265 run on a processor of MD 260, and optionally stored on a memory portion of MD 260. Customer device 540 is in communication with service provider web server 530 over a wireless network, such as the Internet, which is denoted cookie/username band 550. MD 260 is in communication with TS 210 over a wireless network, such as a cellular network, which is denoted customer band 580. MD 260 is in communication with service provider web server 530 over a wireless network, such as the Internet, which is denoted password band 590. TS 210 is in communication with service provider web server 530 over a wireless network, such as the Internet, which is denoted service provider band 530.

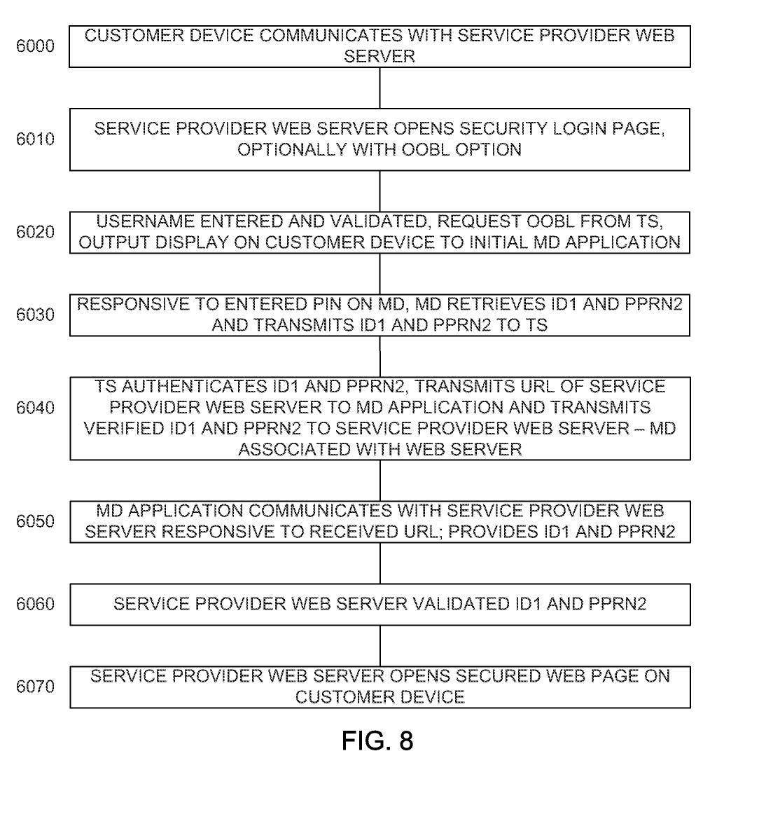

FIG. 8 illustrates a transaction flow utilizing the various domains of FIG. 7, the operation of the figures being described together. In stage 6000, a customer using customer device 540 communicates with service provider web server 530 by entering a web site. In stage 6010, service provider web server 530, opens a security login page. In one embodiment the security login page is opened responsive to a lack of cookie information of customer device 540. In one embodiment, the security login page exhibits a quick OOBL logo 545, i.e. notifies the user of customer device 540 via a display device of customer device 540 that login is to be completed through MD 260. In stage 6020, a username is entered in the displayed login page via an input device of the customer device 540. After validating the entered username, service provider web server 530 requests from TS 210 to arrange an OOBL for the customer including customer ID and service provider information. Service provider web server 530 further outputs a display on the display device of customer device 540 to proceed with login via MD 260.

In stage 6030, responsive to the instructions displayed on customer device 540, application 265 on MD 260 is opened, and responsive to a user gesture to input device 268 of MD 260, including the entering of a PIN, application 265 requests ID 1 from secured ID 1 storage functionality of CE 270 and PPRN2 from CE 270 as described above in relation to FIG. 1B. Application 265 further communicates with TS 210 over customer band 580 and transmits ID1 and PPRN2 retrieved from CE 270 to TS 210.

In stage 6040 TS 210 authenticates the received PPRN2 responsive to information stored on customer credentials database 532 and then requests login information from MD 260, such as a password, by supplying to application 265 of MD 260 the URL of service provider web server 530. TS 210 additionally transmits the received ID1 and PPRN2 to service provider web server 530. MD 260 is thus associated with service provider web server 530, at least for a login process transaction.

In stage 6050, application 265, responsive to a user input gesture authorizing connection with the URL of stage 6040, communicates with service provider web server 530, utilizing the received URL, and supplies login information to provider web server 530. In particular, the login information includes ID1, PPRN2, a password and location information. Other information can be included as requested by the service provider. In stage 6060 service provider web server 530 validates the password, ID1 and PPRN2 responsive to the received information transmitted in stage 6040. In stage 6070, upon validation, service provider web server 530 opens a secured web page on customer device 540 via cookie/username band 550, transmits a login approval message to TS 210 via service provider band 560 and optionally transmits a login approval message to MD 260 via password band 590.

The above described login procedure thus provides increased security when customer device 540 is located in an unsecured location, such as an Internet cafe.

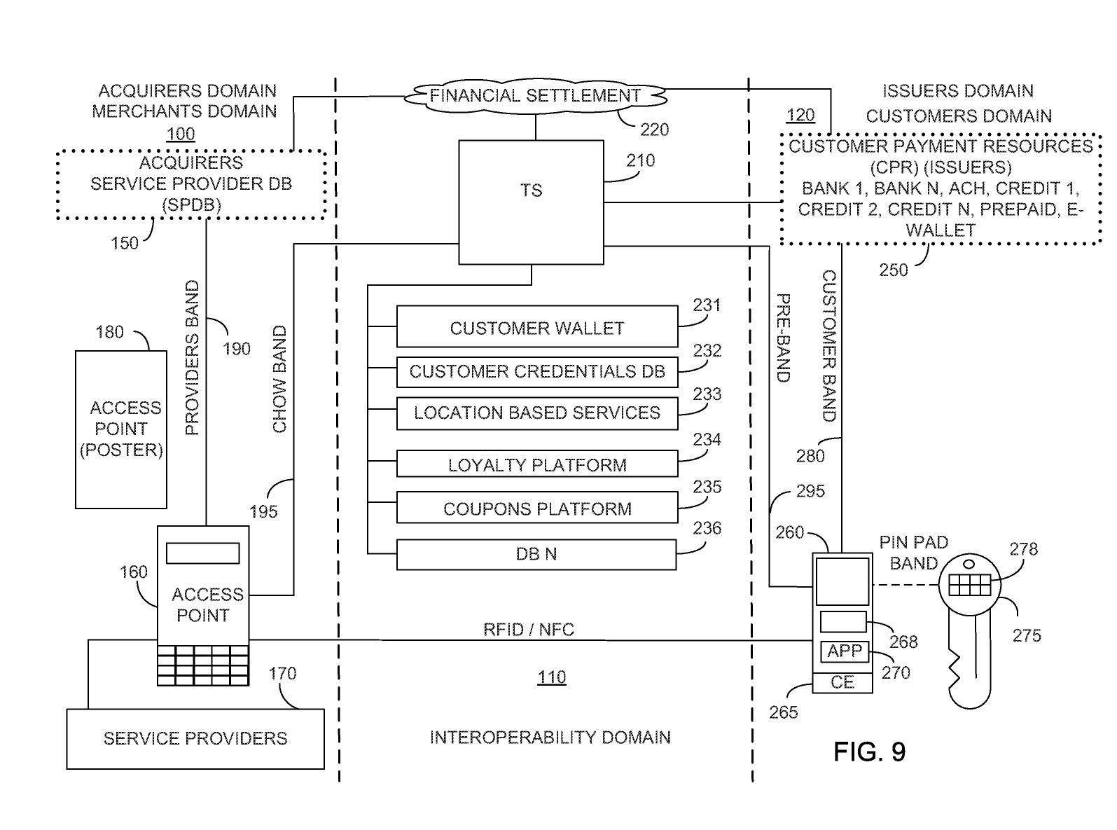

FIG. 9 illustrates a high level block diagram of advantageous partitioning of certain embodiments is in all respects similar to the partitioning of FIG. 1A, with the exception that: acquirers SPDB 150 is in communication with customer's payment resources 250 via financial settlement functionality 220; and access point 160 is in communication with TS 210 over a network 195, denoted CHOW band.

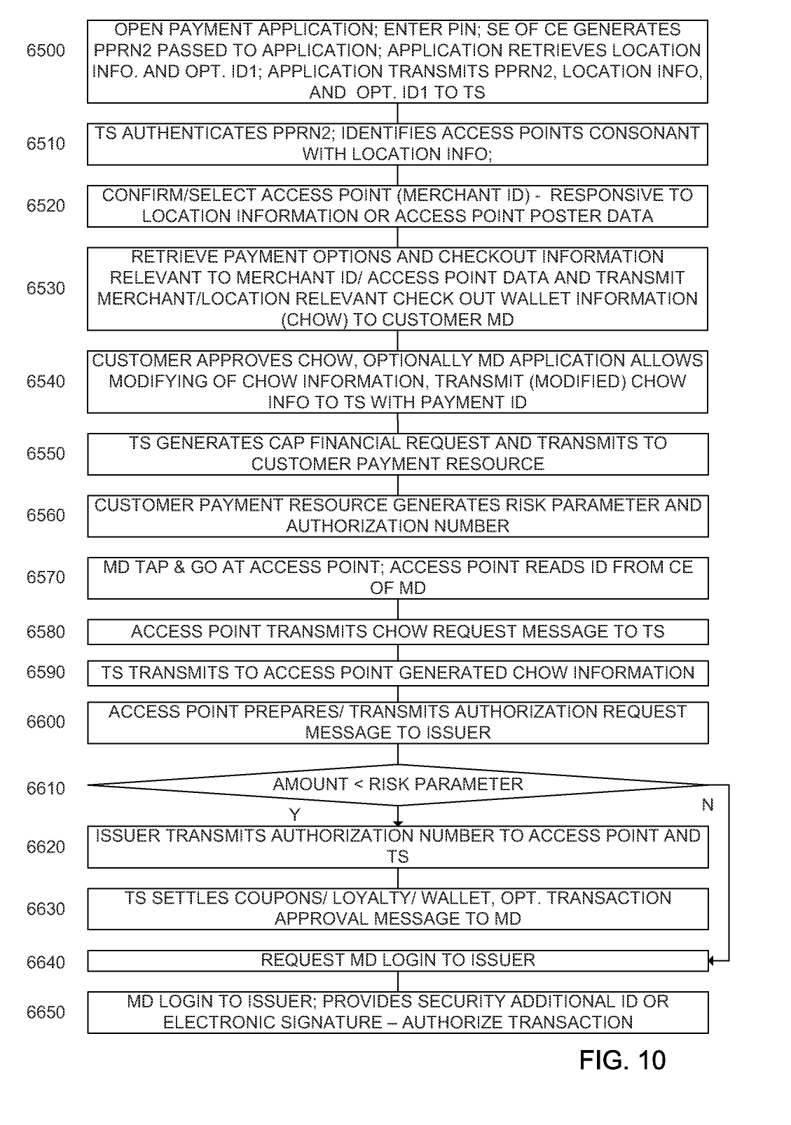

FIG. 10 illustrates a transaction flow utilizing the various domains of FIG. 9, the operation of the figures being described together. In stage 6500, application 265 on MD 260 is initiated, and a PIN which has been preregistered with TS 210 is entered responsive to a user gesture towards input device 268 of MD 260. Application 265 requests ID 1 from secured ID 1 storage functionality of CE 270 and PPRN2 from CE 270 as described above in relation to FIG. 1B. As described above, PPRN2 is generated responsive to the received PIN and further responsive to a PRN key which was initially loaded at registration, and preferably stored in secured keys location 350 of FIG. 1B. There is no requirement that both ID1 and PPRN2 be retrieved, and in another embodiment only PPRN2 is retrieved from CE 270. Application 265 further transmits to TS 210 the optionally retrieved ID1 and the retrieved generated PPRN2 and location information. Location information may be generated by one or both of on board GPS electronics, or responsive to base station transmission calculations. ID1 may be directly transferred, or an encoded identifier may be utilized without exceeding the scope.

In stage 6510 TS 210 authenticates the received PPRN2 responsive to keys stored thereon, such as on customer credentials DB 232, and further identifies all access points 160 registered with TS 210 in geographic proximity to MD 260 responsive to the transmitted location information of stage 6510. In particular, in the event that only a single access point 160 registered with TS 210 exhibits a location consonant with the received location information transmitted in stage 6500, TS 210 transmits the name of the identified access point 160 to MD 260 for confirmation. In the event that a plurality of access points 160 are consonant with the received location information, for example in a mall, a list of registered access points 160 with consonant location information is transmitted to MD 260, and the appropriate access point 160 with which MD 260 is to be associated for a transaction is selected responsive in stage 6520 to a user gesture in cooperation with input device 268 of MD 260. The selected access point 160 is defined by an MID.

Alternatively, as illustrated in FIG. 9, an access point poster or tag 180, which transmits an MID is provided, and MD 260 reads the MID by juxtaposing MD 260 with access point poster or tag 180. Preferably, MD 260 transmits the read merchant ID to TS 210 thus providing location information for MD 260, and particularly information regarding the particular access point 160 with which MD 260 is to be associated for a transaction. Other information may be transferred as well. In one particular embodiment, location information for the particular access point 160 is compared with the received location information for MD 260, and if not consonant, i.e. not geographically feasible, any transaction is blocked.

In stage 6530, the MID with which MD 260 is to be associated for a transaction is transmitted to the various databases 231-236, to determine if any promotions, loyalty benefits, pre-purchase coupons, or gift certificates, without limitation, are relevant to the particular MID for the particular MD 260. Similarly, information regarding payment options for the particular MID is determined, and the relevance to the customer's wallet is retrieved from customer wallet functionality 231. Any relevant coupons retrieved from customer wallet functionality 231 and/or coupons platform 235 may be optionally validated by the issuer. CHOW information is generated by TS 210 and transmitted to MD 260, the CHOW information being advantageously defined in relation to the particular access point 160 and is thus location relevant, exhibiting only offers, discounts or payment options relevant to the particular access point 160 with which MD 260 has indicated is to be associated for a transaction.

In optional stage 6540, a user of MD 260 may modify the received CHOW, particularly selecting from among various payment options and/or agreeing to utilize one or more benefits offered responsive to a user gesture in cooperation with input device 268 of MD 260. Any CHOW based selections are transmitted to TS 210, as a modified CHOW or as information regarding selections made. It is to be noted that all of the above mentioned communication has been accomplished between TS 210 and MD 260 exclusively along pre-band 295 which is secured, in one embodiment by a secure sockets layer (SSL). The CHOW information preferably includes an identifier of the desired payment method of the user of MD 260, denoted as payment ID.

In stage 6560, TS 210, responsive to the received CHOW based selections, or simple CHOW approval, of stage 6550, generates a cap financial transaction request from an issuer within customer's payment resources 250. The cap financial request preferably comprises the above mentioned ID1, the initially generated PPRN2, the selected payment ID and an identifier of the particular selected access point 160, i.e. the merchant ID. Alternatively, a newly generated authenticated PRN is utilized in place of PPRN2.

In stage 6560, the issuer, or other payment resource, calculates a risk parameter, generates an authorization number. The risk parameter typically comprises a financial transaction limit, below which no further authorization is required. In one embodiment, the risk information is generated responsive to the received PRN. Optionally, the risk information is transmitted to TS 210.

In stage 6570, once the user associated with MD 260 has determined the precise desired transaction, CE 270 of MD 260 is juxtaposed with access point 160, i.e. in a Tap and Go process. Access point 160 reads an ID of MD 260. In one embodiment the read ID is a Track 2 ID registered with an issuer, as know in the prior art. In another embodiment the read ID is an ID preregistered with financial settlement functionality 220. In yet another embodiment, the ID comprises the MSISDN of MD 260. Optionally, the read ID is ID1 as described above.

In stage 6580, responsive to the read ID of stage 6580, access point 160 prepares a CHOW request message comprising the read ID of stage 6580 and the merchant ID and transmits to TS 210 the CHOW request message. In optional stage 6590, responsive to the request of stage 6580, TS 210 transmits to access point 160 the generated CHOW information and the received ID.

In stage 6600, responsive to the received ID and CHOW information, access point 160 prepares an authorization request message to conclude the transaction for transmission to the issuer. In the embodiment where the ID is an issuer registered Track 2 ID, the authorization request message is transmitted to the issuer via acquirers SPDB 150 and financial settlement functionality 220. The authorization request message is generated comprising: the ID read during the Tap and Go procedure; the merchant ID for access point 160 and a transaction identifier.

In stage 6610, the issuer compares the amount included in the transaction identifier with the risk parameter generated above, and if the amount is less than the risk parameter, in stage 6620 the above generated authorization number is transmitted to access point 160 via financial settlement functionality 220 and acquirers SPDB 150 to complete the transaction. Additionally, the authorization number is transmitted TS 210.

In stage 6630, any gift, coupon or loyalty information is transmitted to the respective database/server by TS 210. A transaction approval message is transmitted to MD 260 by TS 210, optionally including further local relevant information, such as promotions by adjacent vendors.

In the event that in stage 6610 the transaction amount is greater than the generated risk parameter, in stage 6640 the issuer notifies TS 210, and TS 210 transmits to MD 260 an issuer authorization request message. Specifically, a message is transmitted from TS 210 to MD 260 requesting that MD 260 log into the issuer/user domain.

In stage 6650 MD 260 logs into the directed issuer web page. The issuer web page may authorize the transaction, but typically will require some identification, such as a PIN or electronic signature. In one embodiment, the required identification is responsive to the particular payment ID. Upon receipt of the identification, and in the event that the issuer agrees to authorize the transaction, as described above in relation to stage 6620-6640.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”. The term “connected” is not limited to a direct connection, and connection via intermediary devices is specifically included.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A transaction system comprising:
a mobile device comprising a display;
a transaction server; and
a communication network arranged to provide communication between said mobile device and said transaction server,
wherein said mobile device is arranged to transmit identification information to said transaction server via said communication network,
and wherein said transaction server is arranged to:
identify said mobile device responsive to said mobile device transmitted identification information;
associate said identified mobile device with a particular access point;
transmit, via said communication network, transaction information to said mobile device, said transmitted transaction information responsive to said associated particular access point,
wherein said mobile device is arranged to output onto said display information responsive to said transmitted transaction information.

2. The transaction system according to claim 1, wherein said transaction server is arranged to obtain location information regarding said mobile device, said association of said identified mobile device with the particular access point responsive to the obtained location information.

3. The transaction system according to claim 1, wherein said transaction server is in communication with an electronic wallet functionality associated with said mobile device, and wherein said transaction information is further responsive to said electronic wallet functionality.

4. The transaction system according to claim 3, wherein said mobile device is further provided with an input device, and wherein said mobile device is arranged to:
allow for modification of said transaction information responsive to said input device; and
transmit information regarding the modification to said server.

5. The transaction system according to claim 1, wherein the particular access point is a web server.

6. The transaction system according to claim 5, further comprising:
a user device arranged to provide at least some identification information associated with said mobile device to said web server, and wherein
said web server is arranged to transmit said user device provided identification information to said transaction server, said transaction server arranged to obtain an address of said mobile device responsive to said transmitted user device provided identification information.

7. The transaction system according to claim 1, wherein said mobile device transmitted identification information comprises a pseudo random number generated responsive to a key.

8. The transaction system according to claim 7, wherein said mobile device is further provided with an input device, and wherein said mobile device transmitted identification information comprises a pseudo random number generated responsive to a personal identification number entered via said input device.

9. The transaction system according to claim 8, wherein said mobile device comprises a secure element arranged to:
generate said pseudo random number generated responsive to the key; and
generate said pseudo random number generated responsive to the personal identification number.

10. The transaction system according to claim 9, wherein said secure element further comprising a quarantine functionality arranged to:
read data via a communication interface;
quarantine said read data; and
transmit said quarantined data to said transaction server.

11. The transaction system according to claim 7, wherein said mobile device transmitted identification information further comprises an unencrypted readable identifier.

12. The transaction system according to claim 7, further comprising a secure device in communication with said mobile device, wherein said pseudo random number generated responsive to the key is generated by said secure device and transmitted to said mobile device via a short range communication.

13. The transaction system according to claim 1, further comprising at least one of a loyalty platform and a coupons platform in communication with said transaction server, wherein said transmitted transaction information is further responsive to said at least one platform.

14. A method of providing transaction information, the method comprising:
transmitting identification information from a mobile device to a transaction server;
identifying the mobile device responsive to the mobile device transmitted identification information;
associating said identified mobile device with a particular access point;
transmitting transaction information to the mobile device, said transmitted transaction information responsive to said associated particular access point; and
outputting onto a display of the mobile device information responsive to said transmitted transaction information.

15. The method according to claim 14, further comprising:
obtaining location information regarding the mobile device
wherein said associating said identified mobile device with the particular access point is responsive to the obtained location information.

16. The method according to claim 14, wherein said transmitted transaction information is further responsive to an electronic wallet functionality.

17. The method according to claim 16, further comprising:
enabling modification of said transaction information responsive to an input device of the mobile device; and
transmitting information regarding the modification to the transaction server.

18. The method according to claim 14, wherein the particular access point is a web server.

19. The method according to claim 18, further comprising:
providing a user device arranged to provide at least some identification information associated with the mobile device to the web server;
transmitting said user device provided identification information from the web server to the transaction server; and
obtaining an address of the mobile device responsive to said transmitted user device provided identification information.

20. The method according to claim 14, further comprising:
generating a first pseudo random number generated responsive to a key, wherein the provided mobile device transmitted identification information comprises said generated first pseudo random number.

21. The method according to claim 20, further comprising:
providing the mobile device, wherein said provided mobile device is further provided with an input device;
generating a second pseudo random number responsive to a personal identification number entered via said input device,
wherein said mobile device transmitted identification information further comprises said generated second pseudo random number.

22. The method according to claim 21, wherein said provided mobile device comprises a secure element arranged to generate said first and second pseudo random numbers.

23. The method according to claim 22, wherein said secure element performs a method comprising:
reading data via a communication interface;
quarantining said read data; and
transmitting said quarantined data to said transaction server.

24. The method according to claim 20, wherein said mobile device transmitted identification information further comprises an unencrypted readable identifier.

25. The method according to claim 20, further comprising providing a secure device,
wherein said first pseudo random number generated responsive to the key is generated by said secure device, the method further comprising transmitting said first pseudo random number to the mobile device via a short range communication.

26. The method according to claim 14, wherein said transmitted transaction information is further responsive to one of a loyalty platform and a coupons platform.
